(19) United States
(12) Patent Application Publication
(10) Pub. No.: US 2008/0257162 A1
(43) Pub. Date: Oct. 23, 2008

(54) EFFICIENT DROP SEPARATOR

(75) Inventors: Georg Neubauer, Dallgow-Doberitz (DE); Andre Voss, Neuruppin (DE); Lambertus Huisken, Ratingen (DE); Qiang Xu, Starnberg (DE)

Correspondence Address: BAINWOOD HUANG & ASSOCIATES LLC, 2 CONNECTOR ROAD, WESTBOROUGH, MA, 01581, US

(73) Assignee: REA PLASTIK TECH GMBH, Neuruppin (DE)

(21) Appl. No.: 12/061,187

(22) Filed: Apr. 2, 2008

Related U.S. Application Data
(63) Continuation of application No. PCT/EP2006/009897, filed on Oct. 13, 2006.

(30) Foreign Application Priority Data
Oct. 14, 2005 (DE) 10 2005 049 165.0

(51) Int. Cl. B01D 45/10

(52) U.S. Cl. 96/296

(57) ABSTRACT

Drop separator arrangement for a gas scrubber, with at least one drop separator layer which comprises a plurality of profile sets having drop separator lamellae arranged in a V-shaped manner and which is equipped with at least one scavenging device for the regular washing of the drop separator lamellae, the profile sets being capable of being arranged on carrying beams of the gas scrubber, characterized in that the drop separator lamellae have a mounting which is arranged in the flow shadow of the carrying beam.

### CROSS REFERENCE TO RELATED APPLICATIONS

This Patent Application is a Continuation of PCT application PCT/EP2006/009897 filed Oct. 13, 2006 and entitled “Efficient Mist Collector”, the contents and teachings of which are hereby incorporated by reference in their entirety.

### BACKGROUND

The present invention relates to a drop separator system for flue-gas scrubbers or other gas scrubbers, consisting of two or three drop separator levels through which the gas stream flows vertically, the drop separators being installed in a roof-shaped set-up. A scavenging device for the periodic scavenging of the drop separator is installed in each case on the inflow side and on the outflow side of the drop separator. The invention is employed particularly preferably in the sector of flue-gas desulphurization.

The combustion of coal gives rise, inter alia, to sulphur dioxide gas which is a substantial cause of the death of forests. There are various methods for extracting the harmful sulphur dioxide from the flue gas. The wet method, as it is known, is used most often. In this, the unpurified flue gas is sprayed in a water tower, also called an absorber tower or a gas scrubber, with a mixture of water and limestone, what is known as a washing suspension, with the result that the sulphur dioxide is largely absorbed due to chemical reactions. It is thus possible to achieve a degree of desulphurization of more than 90%. In this case, the gaseous sulphur dioxide first dissolves in the washing liquid. Subsequently, due to the reaction of sulphur dioxide and limestone, calcium sulphite and carbon dioxide are obtained. The washing suspension laden with calcium sulphite collects in the lower part of the washing tower, in the absorber sump. By air being injected (oxidation), the liquid is enriched with oxygen, and a gypsum suspension occurs. After the extraction of the water, gypsum with a residue moisture of up to 10% is obtained in pourable form and is available as a useful product for delivery to the building industry.

The drop separators, as a rule, are installed downstream of the gas washing in the gas flow direction and cover the entire cross section of the round or angular gas scrubber tower. The drop separator is in this case formed by curved lamellae which lie parallel to and at a defined distance from one another and on which the drops contained in the gas flow are precipitated. The precipitated drops form a liquid film which, obeying the law of gravity, flows off downwards or falls in large drops downwards counter to the gas stream.

Since flue gas is heavily laden with fly ash and gypsum is formed during the further desulphurization process, there is always the risk that these solid particles are deposited on the drop separator and possibly even block this. Consequently, below the respective separator layer and often also above it (downstream of the drop separator in the gas flow direction), scavenging devices are installed, which periodically wash the drop separator lamellae and eliminate possible deposits. This scavenging device consists, inter alia, of pipes with nozzles inserted in them.

Drop separators set up in the form of a roof, that is to say configurations with a V-shaped arrangement of inclined lamellae, have proved beneficial both with regard to cleaning off and keeping clean and in terms of a reliable separation performance. The drop separator lamellae of streamlined shape deflect the gas stream laden with liquid. The drops cannot perform this deflection on account of their inertia, but, instead, rebound onto the drop separator lamellae (rebound-surface separator). This gives rise to a liquid film which then runs off downwards. In order to adapt the performance to the said object, the drop separators are offered with special shapes and properties. This ensures the reliable removal of the liquid, whilst at the same time affording a high separation performance. Conventional forms of construction of these drop separators with inclined drop separator lamellae are known, for example, from DE 195 01 282 or DE 195 21 178. The roof-shaped drop separator is meanwhile being used by many power stations because of these advantages.

A decisive advantage is the reliable separation performance at high vertical gas velocities of more than 5 m/s, up to inflow gas flow velocities of 6.5 to 7.5 m/s, depending on the configuration. configuration. Conventional flat drop separators have their performance limit at 5.2 to 5.5 m/s (vertical inflow gas stream). The higher performance limit of roof-shaped drop separators is particularly advantageous for the operation of large plants for large power stations. In these plants, which have, for example, a diameter of 12 m to 17 m and are operated under full load at a basic velocity of 3.5 m/s to 3.8 m/s, operational conditions and structural configuration give rise to local velocity peaks of 5 m/s to 6 m/s and, in individual instances, even more. Such velocity peaks lead, in conventional flat drop separators, to local failure and, consequently, a considerable drop breakaway. Performance of the overall drop separator is thereby considerably reduced, and contamination of the following plants in the flue-gas duct occurs.

Owing to these developments, the performance requirements have once more increased markedly. These modern plants are operated at markedly higher basic velocities, for example between 4.0 m/s and 4.5 m/s. Furthermore, markedly greater fluctuations in the basic velocity may occur locally. Even local velocity peaks of up to 10 m/s have been observed in individual instances.

The evaluation of these velocities must allow for the fact that the inflow velocity of the drop separator is, in turn, 15% to 25% higher than the basic velocity in the plant. In the region of the drop separator, the open gas-throughflow cross-sectional area narrows due to carrying beams (on which the drop separator lies), due to the structural configuration of the drop separators and because individual regions are blinded. This leads to a further rise in the basic velocity and to an even higher inflow velocity for the drop separator. Basic velocities of 4.0 m/s to 4.5 m/s become an inflow velocity of 5.0 to 5.5 m/s. Correspondingly, velocity peaks of 6-8 m/s become inflow velocity peaks of 7.5 to 10 m/s, in individual instances up to 12 m/s. These velocities over attack even the currently conventional roof-shaped drop separators.

At the same time, the frequent problems with contaminations in heat exchangers following the drop separator have made power stations more sensitive with regard to the performance problems of the drop separator. The requirements as regards pressure loss, the duration of an operating cycle and the characteristic value “residue content of drops in the flue gas” downstream of the drop separator have been markedly intensified. Where, 10 years ago, residue contents of 100 to 150 mg/m³ were still required, nowadays 30 to 50 mg/m³ are mostly required as a guaranteed value for the residue content. The conventional roof-shaped drop separator, meanwhile, reaches its performance limits under these conditions.

Both trends, to be precise the higher basic velocity with the higher velocity peaks, on the one hand, and the intensified requirements as to the separation performance, on the other hand, point to the need to develop further the roof-shaped drop separators known hitherto.

### SUMMARY

Proceeding from this, the object of the invention is at least partially to solve the technical problems outlined with regard to the prior art. In particular, a drop separator arrangement is to be specified which has a particularly good separation behavior at high velocities of the flue gas.

These objects are achieved by means of a drop separator arrangement according to the features of Patent claim 1. Further advantageous refinements are specified in the dependently formulated patent claims, whilst the features listed individually there may be combined with one another in any desired technologically expedient way and indicate further refinements of the invention.

Accordingly, a drop separator arrangement for a gas scrubber is proposed, which is equipped with at least one drop separator layer, with a plurality of profile sets having drop separator lamellae arranged in a V-shaped manner and with at least one scavenging device for the regular washing of the drop separator lamellae. In this case, the profile sets can be arranged on carrying beams of the gas scrubber, the drop separator lamellae having a mounting which is arranged in the flow shadow of the carrying beam. The term “mounting” means, in particular, end plates, as they are known, which serve for the end-face reception or fastening of the drop separator lamellae, or similarly acting components. The term “flow shadow”, in this context, means, in particular, that the mounting is arranged essentially outside the free flow cross section below the sets of drop separator lamellae. In other words, this could also mean, in particular, that the drop separator separator lamellae structure extends, parallel to the plane of the carrying beams, over a distance which is greater than the distance between the carrying beams serving as a rest.

What is meant in this case, in particular, is a drop separator arrangement for gas scrubbers and the like, which has one, two or more drop separator layers which consist in each case of at least one row of drop separator lamellae arranged in a roof-shaped or V-shaped manner. In this case, these are equipped with a scavenging device for regular washing. The arrangement is characterized in that the profile sets are arranged, upright, on the carrying beams, in order to minimize the blocking of the scrubber cross section by the separator structure. Thus, the drop separator structure is changed such that the inflow velocity is reduced, the structural features causing breakaway are eliminated and the general configuration of the drop separator is modified.

It is advantageous that the profile sets are secured, by a suitable shaping of the rests and carrying layers, from slipping off from these and, by means of spacers positioned between the profile sets, are held in position and protected from distortion under heat. The structure is shaped such that, on the one hand, it is possible to walk around between the sets and, on the other hand, a maximum scrubber cross section can be utilized for separation.

The drop separator arrangement preferably has profiles which are introduced in an inclined arrangement (preferred form of construction at 35° C.) into a contour-milled end plate, so that leakages between the end plate and the profiles are avoided.

According to a further refinement of the drop separator arrangement, a sufficient distance between two drop separator layers avoids the situation where separating vortices from the first drop separator layer, as seen in the flow direction, are immediately introduced into the drop separator lamellae of the second layer. In this case, it is advantageous that the routing of the gas stream and that of the stream of separated liquid are separated, in order to avoid a renewed entrainment of the already separated liquid from the mass raining down.

The drop separator arrangement is developed in that the stream of separated liquid flowing off can flow off from a lamella uninterruptedly onto the end plate and from there downwards.

Finally, it is also advantageous that the stream flowing off flows off in a pressureless zone (that is to say, a zone lying in the lee of the gas stream) from the end plate and onto the carrier and can flow from there along the carrier downwards.

### BRIEF DESCRIPTION OF THE DRAWINGS

The foregoing and other objects, features and advantages will be apparent from the following description of particular embodiments of the invention, as illustrated in the accompanying drawings in which like reference characters refer to the same parts throughout the different views. The drawings are not necessarily to scale, emphasis instead being placed upon illustrating the principles of various embodiments of the invention.

FIG. 1: shows a drop separator arrangement of the known type of construction;

FIG. 2: shows a detail of the drop separator arrangement from FIG. 1;

FIG. 3: shows a first exemplary embodiment of the drop separator arrangement according to the invention;

FIG. 4: shows a drop separator arrangement of a further known type of construction;

FIG. 5: shows a first detail from FIG. 4;

FIG. 6: shows a further detail from FIG. 4;

FIG. 7: shows an illustration of gas and liquid flows on a known drop separator arrangement;

FIG. 8: shows a detail of a further design variant of the drop separator arrangement according to the invention;

FIG. 9: shows a detail of a further design variant of the drop separator arrangement according to the invention;

FIG. 10: shows an illustration of the formation of turbulence in a known type of construction of a drop separator arrangement;

FIG. 11: shows an illustration of the turbulences in the liquid stream in a known type of construction of a drop separator arrangement;

FIG. 12: shows a detail of a further design variant of the drop separator arrangement according to the invention; and

FIG. 13: shows an illustration of the gas and liquid flows in a design variant of the drop separator arrangement according to the invention.

### DETAILED DESCRIPTION

As explained, the inflow velocity of the drop separator is markedly higher than the basic velocity of the gas in the plant. The cause of this is that part of the cross-sectional area in the scrubber is blocked by carrying beams and other devices. These carrying beams are necessary so that the drop separators can be installed in the scrubber and, at standstill, the drop separators can be walked upon and cleaned. They are therefore indispensable.

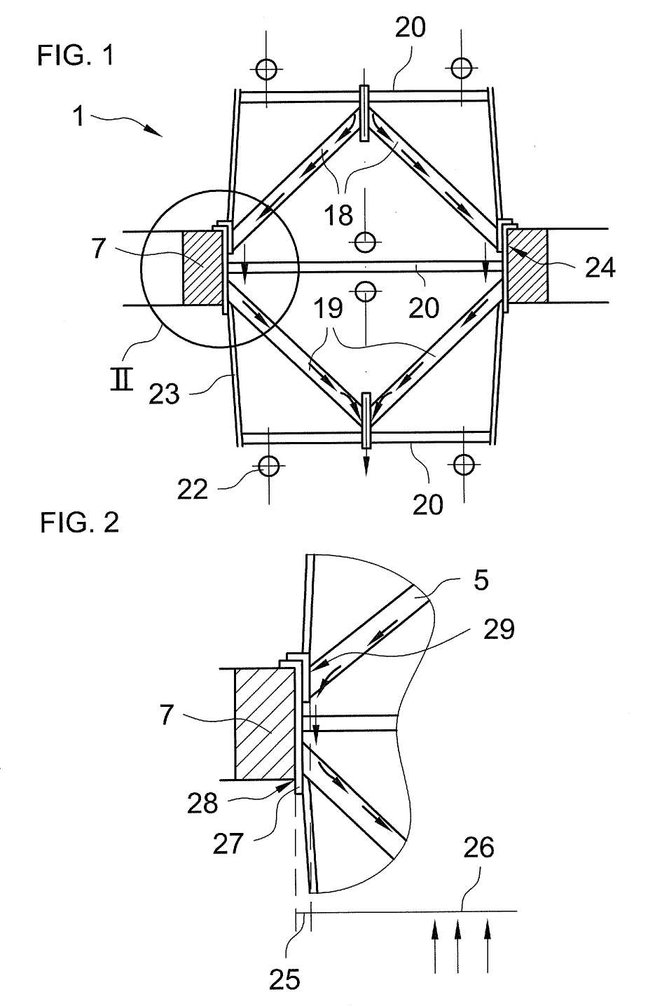

Furthermore, the known type of construction is characterized in that it blocks a further part of the cross section. Thus, FIG. 1 shows a known type of construction of a drop separator arrangement 1 from DE 195 21 178. It is composed of the following parts: two coarse separator sets 18, two fine separator sets 19 and three carrying brackets 20 at the top, in the middle and at the bottom. The pipelines 21 and the side cover 23 can likewise be seen. Furthermore, it may be gathered that the drop separator is suspended on a structure 24 which, in turn, is suspended from the carrying beam 7. This structure 24 blocks a further part of the open gas-throughflow cross section 26 and therefore leads to a further rise in the inflow velocity. Approximately 5% of the still open cross-sectional area is lost because of this additional cover 25 (see also FIG. 2). This leads to a further rise in the inflow velocity.

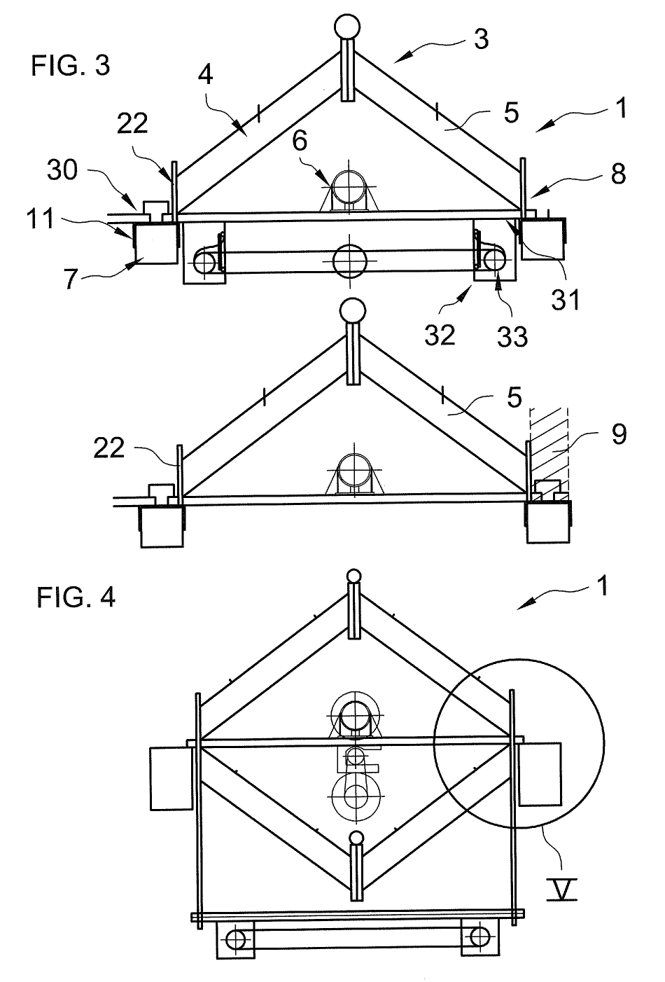

In FIG. 2, the detail, marked by II, from FIG. 1 is illustrated once again, FIG. 2 showing the critical region on the carrying beam 7. An interspace 28 occurs between the carrying beam 7 and a suspension plate 27. The suspension plate 27 has lying on it, in turn, the separator closing plate 29 which holds the drop separator lamellae 5 and also closes off these. The interspace 28 between between carrying beam 7 and suspension plate 27 probably amounts to between 5 mm and 10 mm. The separator closing plate 29 has a thickness of at least 6 mm, probably even about 10 mm. The suspension plate 27 has at least a thickness of 10 mm, probably even about 12 mm. Between the two plates, there is a further interspace of a few millimeters. This results, together, in a space utilization of 30 mm to 40 mm. In the case of an open span of 2000 mm, in the form proposed in DE 195 21 178, approximately 80 mm of the 2000 mm, that is to say 4% of the open cross section, are attributable to this structure.

Whereas, in this case, an arrangement of the drop separators which is suspended or is inserted between the carrying beam 7 is provided, an arrangement standing upright on the carrying beams is proposed as a design variant according to the invention. FIG. 3 presents the solution designed according to the invention.

By the drop separators being set up, as proposed, not only is a narrowing of the open gas-throughflow cross-sectional area avoided, but this is even widened slightly.

On the carrying beam 7 stands a profile set 4 with drop separator lamellae 5 arranged in the V-shaped manner, which bears with its end plate 22, extended downwards, on the rest 11. The end plate 22 does not bear centrally on the carrying beam 7, but is held on the right-hand side of the carrying beam 7 by a spacer plate 30. The pipeline 6 for spraying lies on the carrying bar 31, and from the carrying bar 31 is suspended the pipe mounting 33 with the spray pipe 33 which sprays from above the separator layer lying underneath. The carrying bar 31 has only a width of 35 mm×35 mm and therefore does not block the gas stream. Accordingly, as illustrated at the bottom of FIG. 3, the mounting 8 is arranged in the idealized flow shadow 9 of the carrying beam 7. Although the rest 11 also blocks the open cross section, this blocking is nevertheless uncritical for the drop separator, since it lies upstream of the drop separator in the gas stream. Downstream of the rest 11, the gas stream can spread out again, even as far as downstream of the carrying beam 7, before it enters the drop separator. Consequently, not only is the open cross section available for separation, but also a part of the cross section of the carrying beam. The result is a larger available separation area, as compared with the prior art shown in FIGS. 1 and 2.

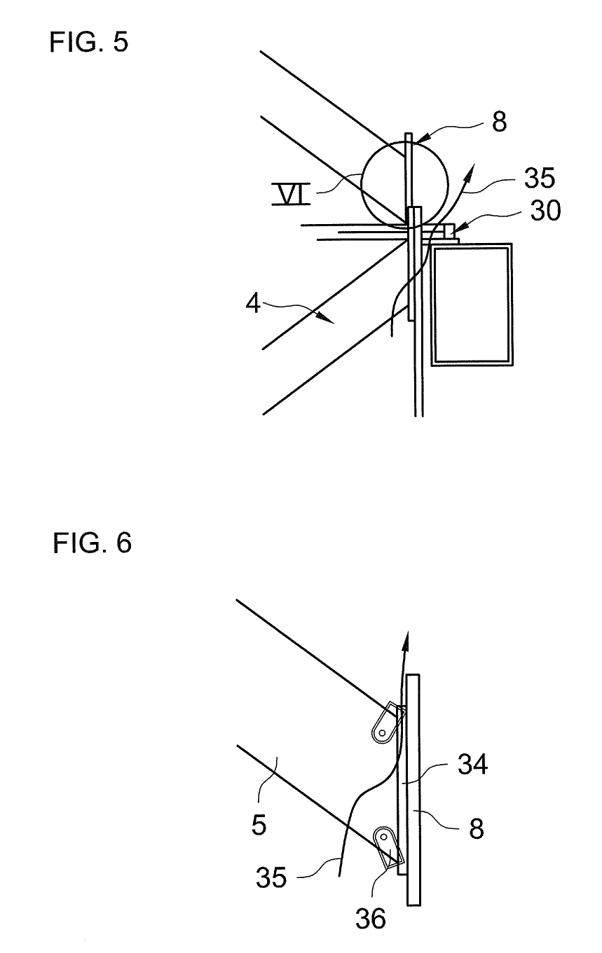

A further weakness of the known form of construction of the roof-shaped drop separator is the design of the separator set. FIG. 4 illustrates diagrammatically the known form of construction of a drop separator arrangement 1, the location marked by V being shown, enlarged, in FIG. 5. The region marked by VI can be seen in FIG. 6. FIGS. 5 and 6 show the cause of the leakage streams 35 occurring hitherto in known forms of construction. These allow leakages, as a result of which the gas stream can flow through, unpurified and undried, past the drop separator. The effect of these leakages rises with an increasing inflow velocity and to an intensified extent causes a breakaway of drops. Furthermore, these leakages lie partially at exactly the location at which the liquid separated in the drop separator flows back, comes loose from the separator surface and falls back downwards into the gas scrubber. The leakage gas stream 35 coming from below is thereby showered with a liquid cascade and can absorb additional liquid. The adverse effect of the leakage stream in terms of the entrainment of drops may thus even be additionally reinforced. FIG. 5 illustrates a leakage stream 35 which flows, unpurified, past a profile set 4 and likewise past the spacer plate 30 at the drop separator plant. A connection between the drop separator lamellae 5 and the mounting 8 has also been carried out by fastening means 36 (such as, for example, pipe systems with grooves for receiving a plurality of drop separator lamellae with securing bolts) which leave a gap 34 between both elements, so that leakage streams 35 are also possible here (see FIG. 6).

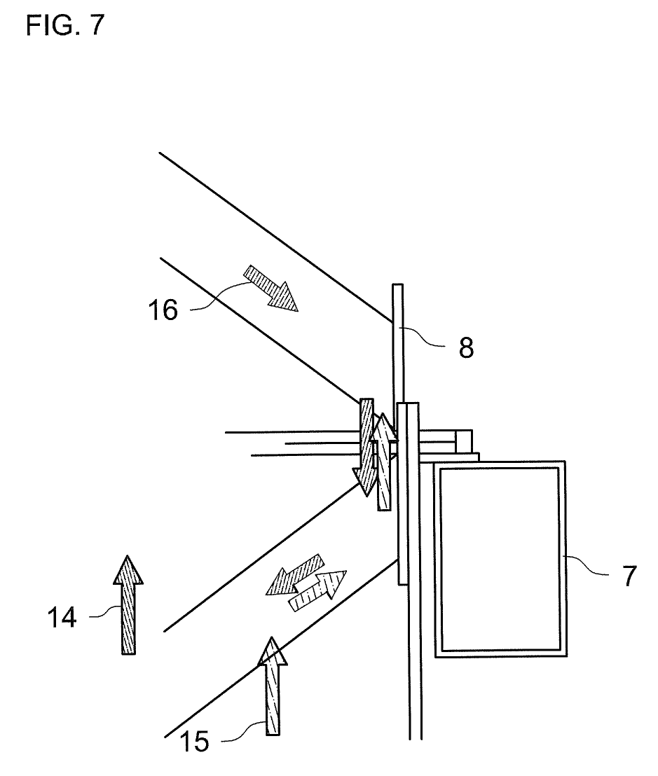

FIG. 7 additionally shows the gas streams 15 and liquid streams 16. Basically, the gas to be purified in this case flows through the drop separator plant 3 in the flow direction 14. In the known form of construction, however, a considerable intermingling of the gas stream 15 or leakage stream and the liquid stream 16 raining down occurs.

In a design variant of the solution designed according to the invention, the drop separator lamellae 5 and the mounting 8 are arranged such that no open interspace or gap 34, through which a leakage gas stream 35 may flow, occurs between the drop separator lamellae 5 and the mounting 8. Furthermore, in the solution designed according to the invention, for example, the fixed connection between the drop separator plant 3 and the end plate 22 avoids the situation where the liquid stream 16 flowing off on the drop separator lamellae 5 and previously separated from the gas stream 15 falls downwards as a rain of drops, counter to the gas stream 16, at the end of the drop separator lamellae 5 and at the same time new drops may be absorbed by this gas stream. Instead, owing to the fixed connection of the drop separator lamellae 5 to the end plate 22, the liquid stream 15 flowing off can pass over from the drop separator lamellae 5 onto the end plate 22, without losing contact with the solid surface. The liquid can then flow off further along the end plate 22 as a film and does not come loose from the profile set 4 until on the carrying beam 7 in a pressureless zone 17 under cover of the carrying beam 7 and of the rest 11 lying on it, in order to flow off downwards.

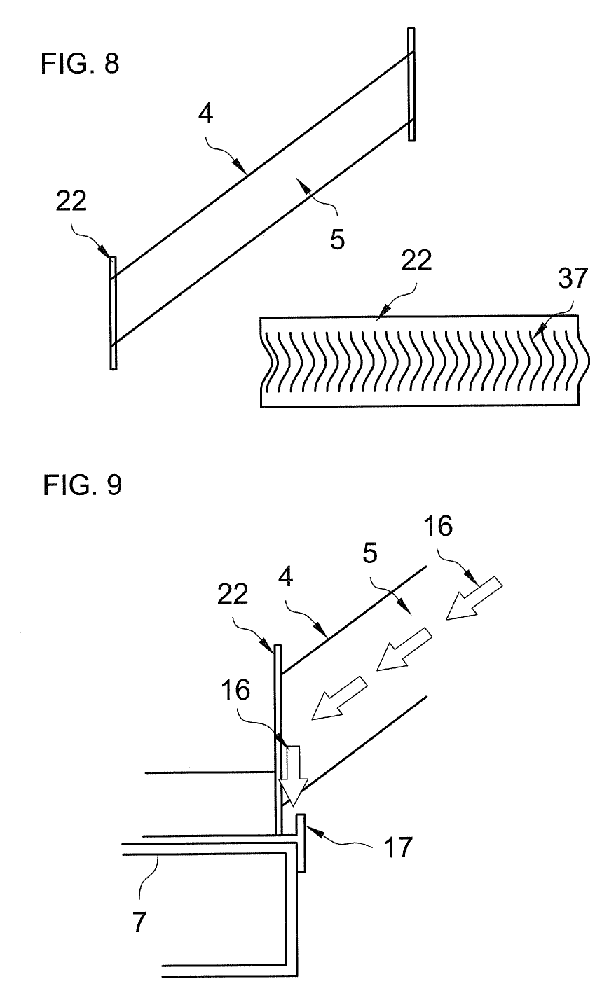

This is also illustrated, then, with reference to FIGS. 8 and 9. It can be seen that the profile set 4 is assembled from drop separator lamellae 5 and end plates 22. The end plates 22 comprise a plastic plate, into which the contour 37 of the drop separator lamellae 5 is milled. The drop separator lamellae 5 are plugged through these milled contours 37 and welded, so that between them there is no open gap through which a leakage gas stream could flow. Thus, here, the liquid stream 16 flowing back, which has previously been separated by the drop separator lamellae 5, is discharged downwards. It becomes clear that this liquid, coming from the drop separator lamellae 5, flows along the end plate 22 into a pressureless zone 17 above the carrying beam 7, so as then to rain down uncritically from the carrying beam 7 into the gas scrubber.

Furthermore, the form of construction illustrated in DE 192 21 178 presents the problem that, because of its arrangement of the profile sets and the resulting gas streams, this adversely influences the separation performance of the drop separator lamellae. In this form of construction, the profiles of the front (upper) drop separator layer are arranged in the form of an upturned V and the profiles of the rear (lower) drop separator layer are arranged in the form of a V. In this case, however, critical disadvantages in terms of the efficiency of the drop separator lamellae are tolerated.

It is known that, when a gas stream flows past a solid body, vortices are separated from this. The drop separator profiles of the lower (first) layer also generate such vortices which separate from the lamellae and flow upwards together with the gas stream. Since the distance between the first and the second layer of the drop separators in the immediate vicinity of the carrying beams is very short, these vortices immediately enter the interspaces between the drop separator lamellae of the second drop separator layer, without being able to experience attenuation due to a certain traveling distance. These turbulences or vortices exert an anti-separation effect there. On the one hand, these turbulences may bring about a situation where drops which are just before separation are removed from the lamella surface again by the force of the turbulence and are thereby prevented from being separated. On the other hand, the turbulences, due to their action on the liquid film both by their force and by their direction of action, may cause secondary drops to be torn out of the liquid film on the drop separator lamellae.

A further effect leads to the result where the distribution of the gas stream in the drop separator is non-uniform and the largest gas volume with the highest velocity in the second drop separator is present exactly in the region in which the most unfavorable separation conditions prevail. This is that region of the second drop separator which adjoins the carrying beam. The separated liquid flowing back collects at this location and then flows off downwards. In this case, a greater liquid quantity in a drop separator lamella leads to a rise in the drop breakaway. The cause of this is that the liquid film takes up part of the open cross section and an acceleration of the gas stream flowing through consequently occurs. This increases the number and quantity of the drops which are torn out of the separated liquid film by the gas stream and are carried away by the gas stream (secondary drops). This effect is reinforced when, in addition to the particularly high liquid quantity, a particularly high gas quantity also occurs at this location. The cause of this compression of the gas is the first drop separator layer (as seen in the flow direction of the gas stream). The drop separator lamellae are, in the gas stream, a resistance which, on account of its form running obliquely upwards, deflects the gas stream upwards and towards the carrying beam. As a result of this deflection, the gas stream is reduced in the middle between the two carrying beams and is compressed at the sides at the carrying beams.

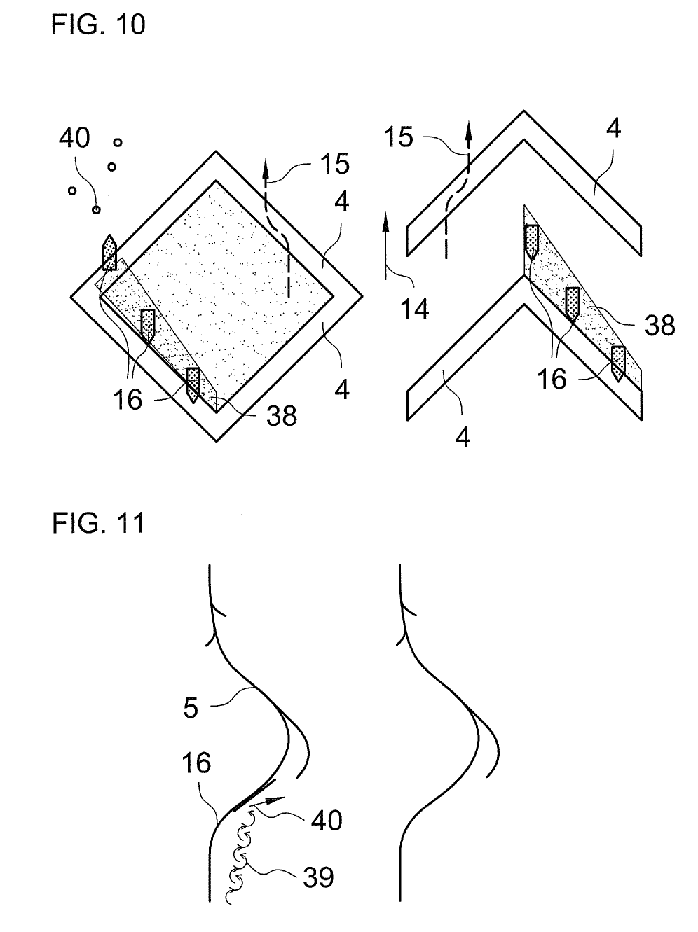

These effects impair the separation behavior of the known drop separator referred to here. FIG. 10 illustrates the turbulences in this drop separator and their influence on the separator layer arranged above. The gas stream 15 flows in the flow direction 14 from the bottom upwards through the two forms of construction with an oppositely directed (left) and co-directional (right) arrangement of the profile sets 4. During the flow through the first lower layer, when the gas streams 15 separate from the drop separator lamellae of the profile sets 4, turbulences are formed which are also present in this region over a region of influence 38 above the profile set 4, for example as a function of the gas velocity. In the oppositely directed arrangement illustrated on the left, this region of influence 38 extends into the space of the following profile set 4, with the result that there is no longer any high separation, but, instead, a considerable portion of the retained or separated liquid stream 16 is entrained again by the gas stream 15 (see also the illustration in FIG. 11). The turbulences 39 have the effect of breaking away the already separated liquid and of the absorption of drops 40 in the gas stream 15. The co-directional arrangement of the profile sets 4 which is illustrated on the right is therefore to be preferred for an effective design of the drop separator plant.

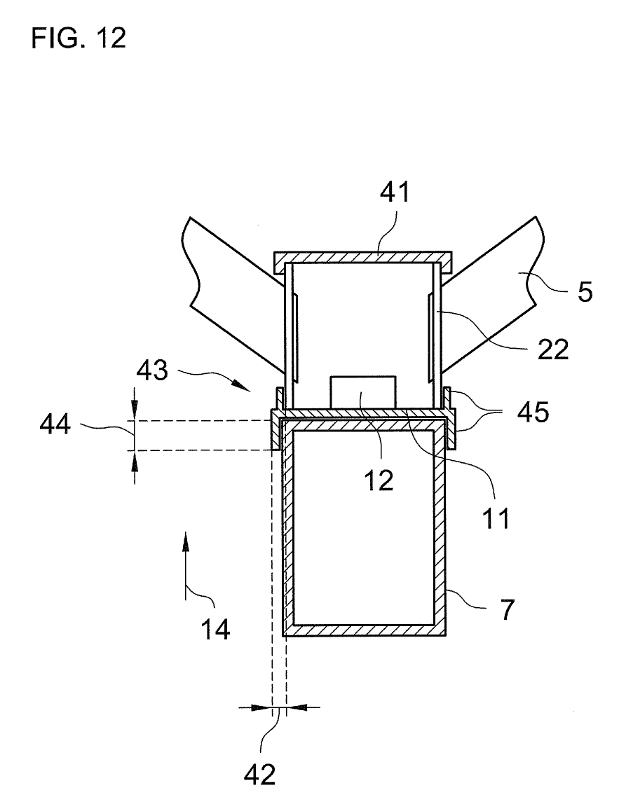

FIG. 12 illustrates a further design variant of the drop separator arrangement 1 according to the invention. A carrying beam 7 is shown in detail, on which lies a rest 11 which is designed, for example, with projections 11 in the edge region which extend alternately upwards and downwards. The downwardly oriented projections 11 (for example, with a height of up to 30 mm and a thickness in the range up to 10 mm) ensure that the position of the rest 11 does not change with respect to the carrying beam 7, in which case additional fastening methods, such as joining connection (welding, screwing, etc.) of the two components, may be dispensed with. The mountings 8 for the drop separator lamellae 5 are positioned on the rest 11. The upwardly directed projections 11 of the rest 11 are provided against the mountings 8 slipping off from the carrying beam 7. These projections are in this case preferably arranged, set back, so that, for example, a desired offset 42 of the mounting 8 with respect to the side of a carrying beam 7 is ensured under all operating conditions in the gas scrubber. A widening 43 of the free flow cross section is consequently achieved, so that, in the flow direction 14 illustrated, the gas stream can partially spread out downstream of the carrying beam 7. In this case, in particular, that region of the mounting 8 which is arranged between the drop separator lamellae 5 and the carrying beam 7 or the rest 11 is positioned in the flow shadow 9 of the carrying beam. In order to avoid a situation where the mountings 8 of adjacent drop separators come too near to one another on a carrying beam 7, between them a spacer 12 is positioned which is formed, for example, by a plurality of profile plates fastened on the rest 11. In the event that the distance between the two mountings 8 is to be very short, for example less than 150 mm, a running board 41 may be at least partially provided, which is connected at least partially to the mountings and which enables operating personnel to walk around on the plant safely.

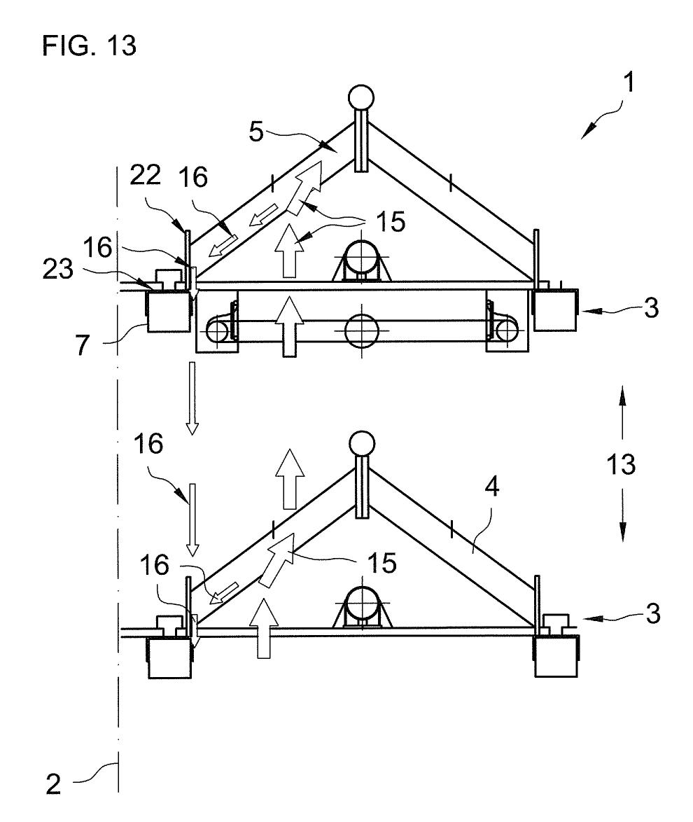

A further variant, designed according to the invention, of the drop separator arrangement 1 is illustrated in FIG. 13. The configuration of the drop separator lamella, end plate 22 and rest 23 on the carrying beam 7 or the arrangement of these three components of the drop separator is designed such that they cooperate in order to remove the separated liquid stream 16 from the second (upper) drop separator layer 2 out of the region of influence of the upwardly directed gas stream 15 and to cause it to rain down, without being influenced by the latter, into the gas scrubber 2. This avoids the situation where the gas stream 15 just largely purified by the first drop separator layer 2 absorbs drops anew from the liquid stream 16 raining down and entrains them into the second drop separator layer 2. The sufficient distance 13 between two drop separator layers 2 avoids the situation where vortices or turbulences breaking away from the first drop separator layer 2, as seen in the flow direction 14, are immediately introduced into the drop separator lamellae 5 of the second layer.

Thus, the residue content of liquid is reduced downstream of the second drop separator layer, because a reduction in the liquid quantity introduced into the drop separator gives rise automatically to a reduction in the residual liquid quantity emerging from the drop separator. A reduction in the liquid quantity introduced into the drop separator immediately causes a reduction in breakaway, since this decreases the quantity of secondary drops which occur due to the impingement of the drops onto the drop separator or by being torn out of the liquid film on the drop separator. The smaller the quantity of liquid in the drop separator, the lower the breakaway.

It should be pointed out that the aspects of the invention which are explained in the general description may be combined with those from the figure description or the versions related to this and lead to further refinements of the invention. Modifications of these which come within the scope of the ability of a person skilled in the art may likewise have further advantages.

### List of Reference Symbols

1 Drop separator arrangement
2 Gas scrubber
3 Drop separator layer
4 Profile set
5 Drop separator lamella
6 Scavenging device
7 Carrying beam
8 Mounting
9 Flow shadow
10 Shaping
11 Rest
12 Spacer
13 Distance
14 Flow direction
15 Gas stream
16 Liquid stream
17 Zone
18 Coarse separator set
19 Fine separator set
20 Carrying bracket
21 Zone
22 End plate
23 Side cover
24 Structure
25 Cover
26 Cross section
27 Suspension plate
28 Interspace
29 Separator closing plate
30 Spacer plate
31 Carrying bar
32 Pipe mounting
33 Spray pipe
34 Gap
35 Leakage stream
36 Fastening means
37 Contour
38 Region of influence
39 Turbulence
40 Drop
41 Running board
42 Offset
43 Widening
44 Height
45 Projection

What is claimed is:

1. Drop separator arrangement for a gas scrubber, with at least one drop separator layer which comprises a plurality of profile sets having drop separator lamellae arranged in a V-shaped manner and which is equipped with at least one scavenging device for the regular washing of the drop separator lamellae, the profile sets being capable of being arranged on carrying beams of the gas scrubber, characterized in that the drop separator lamellae have a mounting which is arranged in the flow shadow of the carrying beam.

2. Drop separator arrangement according to claim 1, characterized in that the profile sets are secured to the carrying beam by means of a rest and are held in position by means of spacers positioned between the profile sets.

3. Drop separator arrangement according to claim 1, characterized in that the drop separator lamellae are introduced in an inclined arrangement into a contour-milled end plate, and leakage between the end plate and the profile set is thereby avoided.

4. Drop separator arrangement according to claim 1, characterized in that a sufficient distance between two drop separator layers avoids the situation where turbulences breaking away from the first drop separator layer, as seen in the flow direction, are introduced immediately into the drop separator lamellae of the second layer.

5. Drop separator arrangement according to claim 1, characterized in that the routings of the gas stream and of the separated liquid stream are spatially separated.

6. Drop separator arrangement according to claim 1, characterized in that the liquid stream can flow off from the drop separator lamellae directly onto the end plate and from there downwards.

7. Drop separator arrangement according to claim 1, characterized in that the liquid stream flows in a pressureless zone from the end plate towards the carrying beam and can flow from there along the carrying beam downwards.
